(19) United States
(12) Patent Application Publication
(10) Pub. No.: US 2022/0314151 A1
(43) Pub. Date: Oct. 6, 2022

(54) MULTI-PANEL AIR FILTER

(71) Applicant: K&N Engineering, Inc., Riverside, CA (US)

(72) Inventors: Jonathan Richard Fiello, Yucaipa, CA (US); Jere James Wall, Helendale, CA (US)

(73) Assignee: K&N Engineering, Inc., Riverside, CA (US)

(21) Appl. No.: 17/713,865

(22) Filed: Apr. 5, 2022

Related U.S. Application Data
(60) Provisional application No. 63/171,357, filed on Apr. 6, 2021.
(60) Provisional application No. 63/252,351, filed on Oct. 5, 2021.

(51) Int. Cl. B01D 46/00; F24F 8/108

(52) U.S. Cl. CPC B01D 46/0005; F24F 8/108; B01D 2279/50

(57) ABSTRACT

An apparatus and methods are provided for an air filter for removing contaminants from air within interior building spaces. The air filter comprises a V-bank filter element for removing contaminants from an airstream flowing through a HVAC system. The V-bank filter element includes filter panels that are angled with respect to one another to form adjacent V-configurations such that front edges of adjacent filter panels are placed in contact and rear edges of adjacent filter panels similarly placed in contact. A top member and a bottom member receive top and bottom edges of the filter panels for supporting the V-configurations. A frame couples with the top member and the bottom member and orients the V-bank filter element within the HVAC system such that the airstream is directed through the V-bank filter element. Openings are disposed in the frame for allowing the airstream to enter the V-bank filter element.

### PRIORITY

This application claims the benefit of and priority to U.S. Provisional Application, entitled “Multi-Panel Air Filter,” filed on Apr. 6, 2021, and having application Ser. No. 63/171,357; and also claims the benefit of and priority to U.S. Provisional Application, entitled “Multi-Panel Air Filter,” filed on Oct. 5, 2021, and having application Ser. No. 63/252,351; the entirety of both of said applications being incorporated herein by reference.

### FIELD

Embodiments of the present disclosure generally relate to the field of filter devices. More specifically, embodiments of the disclosure relate to an apparatus and methods for a multi-panel air filter to remove airborne molecular contaminants and volatile organic compounds from air within interior building spaces.

### BACKGROUND

Heating, ventilation, and air conditioning (HVAC) systems generally operate to provide optimal indoor air quality to occupants within interior building spaces. HVAC systems achieve optimal indoor air quality by conditioning air, removing particle contaminants by way of ventilation and filtration of air, and providing proper building pressurization.

While there are many different HVAC system designs and operational approaches, and each building design is unique, HVAC systems generally share a few basic design elements. For example, outside air (“supply air”) generally is drawn into a HVAC system of a building through an air intake. Once in the HVAC system, the supply air is filtered to remove particle contaminants, then heated or cooled, and then circulated throughout the building by way of an air distribution system. Many air distribution systems comprise a return air system configured to draw air from interior building spaces and return the air (“return air”) to the HVAC system. The return air is then mixed with supply air and then filtered, conditioned, and circulated throughout the building. Often times, a portion of the air circulating within the building may be exhausted to the exterior of the building so as to maintain a desired barometric pressure within the building.

As will be appreciated, the effectiveness of the HVAC system to provide an optimal indoor air quality depends largely on an ability of an air filter within the HVAC system to remove particle contaminants from the air within the building. A HVAC system air filter typically comprises fibrous materials configured to remove solid particulates, such as dust, pollen, mold, and bacteria from the air passing through the HVAC system. A drawback to conventional HVAC system air filters, however, is that highly effective air filters capable of removing very small contaminants, such as airborne molecular contaminants and volatile organic compounds (VOCs), tend to restrict airflow through the air filter, thereby making the HVAC system work harder and consume more energy.

Another drawback to conventional HVAC system air filters is that dirty or clogged air filters typically are removed from the HVAC system and discarded, and a new HVAC system air filter is then installed. Further, HVAC system air filters may be unnecessarily discarded and replaced in an effort to increase HVAC system airflow and thus decrease operation costs. Considering that there are millions of buildings with HVAC systems throughout the world, the volume of discarded air filters that could be eliminated from landfills is staggering.

What is needed, therefore, is an air filter that may be periodically cleaned and reused and is configured for removing airborne molecular contaminants and VOCs from air within interior building spaces without obstructing air flow through the air filter.

### SUMMARY

An apparatus and methods are provided for an air filter for removing contaminants from air within interior building spaces. The air filter comprises a V-bank filter element for removing contaminants from an airstream flowing through a HVAC system. The V-bank filter element includes filter panels that are angled with respect to one another to form adjacent V-configurations such that front edges of adjacent filter panels are placed in contact and rear edges of adjacent filter panels similarly placed in contact. A top member and a bottom member receive top and bottom edges of the filter panels for supporting the V-configurations. A frame couples with the top member and the bottom member and orients the V-bank filter element within the HVAC system such that the airstream is directed through the V-bank filter element. Openings are disposed in the frame for allowing the airstream to enter the V-bank filter element.

In an exemplary embodiment, an air filter for cleaning air within interior building spaces comprises: a V-bank filter element for removing contaminants from an airstream; a top member and a bottom member for supporting the V-bank filter element; a frame for coupling with the top member and the bottom member; and one or more openings disposed in the frame for allowing the airstream to enter the V-bank filter element.

In another exemplary embodiment, the V-bank filter element is configured to provide more surface area than traditional filters, reduce the overall pressure drop in a HVAC system, and extend the usable life of downstream filters. In another exemplary embodiment, the frame is configured to orient the air filter within a HVAC system such that the airstream is directed through the V-bank filter element. In another exemplary embodiment, the frame includes a lip and has a shape and size suitable for supporting the air filter within the HVAC system.

In another exemplary embodiment, the V-bank filter element comprises two or more filter panels that are angled with respect to one another to form one or more V-configurations. In another exemplary embodiment, the two or more panels each comprises a filter medium that provides an area through which to pass the airstream and entrap particulates and other contaminates flowing with the airstream. In another exemplary embodiment, the two or more filter panels are arranged into adjacent V-configurations.

In another exemplary embodiment, the top member includes a seat configured to receive top edges of the two or more filter panels such that the two or more filter panels are disposed in the adjacent V-configurations. In another exemplary embodiment, the bottom member includes a seat configured to receive bottom edges of the two or more filter panels such that the two or more filter panels are disposed in the adjacent V-configurations. In another exemplary embodiment, the one or more openings are configured to allow the airstream to enter upstream volumes disposed between adjacent V-configurations.

In another exemplary embodiment, downstream volumes disposed between adjacent V-configurations are configured to allow a clean airstream to exit the V-bank filter element. In another exemplary embodiment, the seats comprising the top member and the bottom member are configured to fixate the V-configurations such that the upstream volumes include substantially identical angles and areas. In another exemplary embodiment, the seats comprising the top member and the bottom member are configured to fixate the V-configurations such that the downstream volumes include substantially identical angles and areas. In another exemplary embodiment, the upstream volumes and the downstream volumes are configured to be substantially identical to one another.

In an exemplary embodiment, a method for an air filter comprises: providing a filter medium comprising two or more filter panels; arranging the two or more filter panels into a V-bank filter element; supporting the V-bank filter element between a top member and a bottom member; and configuring a frame to couple the top member and the bottom member.

In another exemplary embodiment, arranging includes arranging the two or more filter panels into adjacent V-configurations. In another exemplary embodiment, supporting includes seating the two or more filter panels into the top member and the bottom member such that the two or more filter panels are disposed in adjacent V-configurations. In another exemplary embodiment, seating includes fixating the V-configurations such that upstream volumes and downstream volumes are established between pairs of the two or more filter panels. In another exemplary embodiment, configuring the frame includes configuring one or more openings in the frame to allow an airstream to enter the upstream volumes between adjacent V-configurations.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a cross-sectional view of an exemplary-use environment wherein a multi-panel air filter is incorporated into a HVAC system of a building, according to the present disclosure;

FIG. 2 illustrates a schematic view of an exemplary embodiment of a HVAC system comprising a multi-panel air filter in accordance with the present disclosure;

FIG. 3 illustrates an isometric view of an exemplary embodiment of a multi-panel air filter that may be used to clean an airstream flowing through a HVAC system to clean air within interior building spaces;

FIG. 4 illustrates a cross-sectional view of the multi-panel air filter of FIG. 3, taken along a line 4-4; and

FIG. 5 illustrates an isometric exploded view of the multi-panel air filter of FIG. 3, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the multi-panel air filter and methods disclosed herein may be practiced without these specific details. In other instances, specific numeric references such as “first panel,” may be made. However, the specific numeric reference should not be interpreted as a literal sequential order but rather interpreted that the “first panel” is different than a “second panel.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, heating, ventilation, and air conditioning (HVAC) systems operate to provide optimal indoor air quality to occupants within interior building spaces. HVAC systems achieve optimal indoor air quality by conditioning air, removing particle contaminants by way of ventilation and filtration of air, and providing proper building pressurization. The effectiveness of a HVAC system to provide an optimal indoor air quality depends largely on an ability of an air filter within the HVAC system to remove particle contaminants from the air within the building. A drawback to many conventional HVAC system air filters, however, is that highly effective air filters capable of removing very small contaminants tend to restrict airflow through the air filter, thereby making the HVAC system work harder and consume more energy. Another drawback to conventional HVAC system air filters is that dirty or clogged air filters typically must be removed from the HVAC system and discarded, and a new HVAC system air filter is then installed. Further, HVAC system air filters may be unnecessarily discarded and replaced in an effort to increase HVAC system airflow and decrease operation costs. Embodiments presented herein provide a reusable multi-panel air filter configured to remove airborne molecular contaminants and volatile organic compounds from air within interior building spaces.

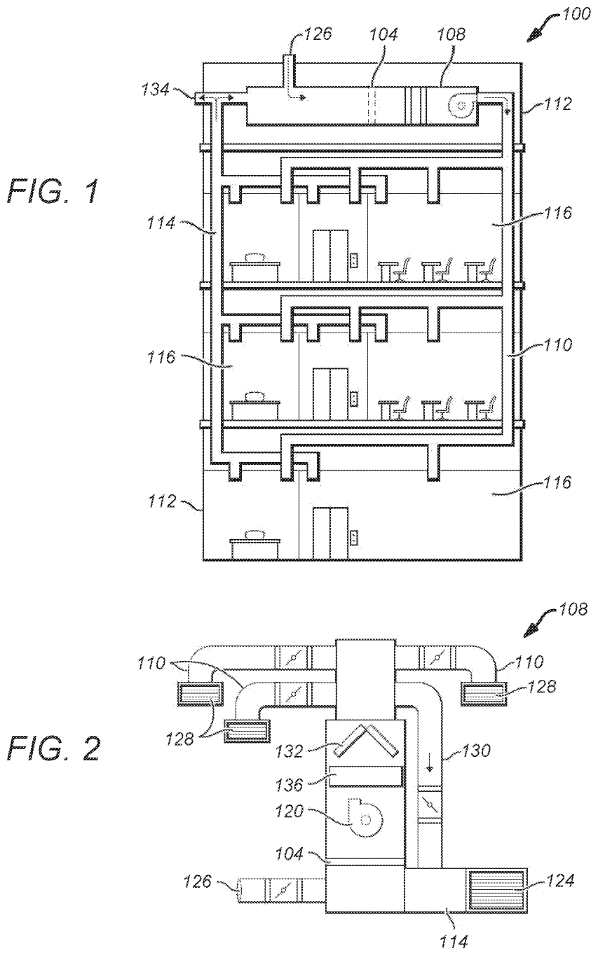

FIG. 1 illustrates an exemplary-use environment 100 wherein an air filter 104 is incorporated into a HVAC system 108 of a building 112 to clean an airstream drawn through the air filter 104. Although the building 112 illustrated in FIG. 1 comprises a multi-story office building, it should be understood that the building 112 may comprise any of various structures, such as warehouses, storage spaces, server rooms, clean rooms, office spaces, residential homes, apartments, condominiums, and the like, without limitation. After passing through the air filter 104, the airstream is routed into one or more building spaces 116 by way of a supply ductwork 110. Air within the building spaces 116 is routed back to the HVAC system 108 by way of a return ductwork 114. It will be appreciated that the building 112 may comprise multiple stories, each of which stores including one or more building spaces 116, as illustrated in FIG. 1, or may comprise a single-story building, including but not limited to a detached residential home.

FIG. 2 illustrates a schematic view of an exemplary embodiment of a HVAC system 108 that may be used to clean air within building spaces 116. The HVAC system 108 generally comprises a fan 120 configured to draw a return airstream 124 from the building spaces 116 through the air filter 104 whereby airborne molecular contaminants, volatile organic compounds (VOCs), and other particle contaminants are removed from the airstream. Particle contaminants removed from the return airstream 124 are entrapped in the air filter 104. The fan 120 then pushes a clean airstream 128 through an air conditioning system 132 and a heater core 136 and then into the building spaces 116. As will be appreciated, the air conditioning system 132 and the heater core 136 facilitate providing a consistent, comfortable temperature within the building spaces 116 by respectively cooling and heating the clean airstream 128, as needed. As further shown in FIG. 2, the return airstream 124 may be combined with an outside airstream 126, as well as with a bypass airstream 130 airstream so as to maintain a desired barometric pressure within the HVAC system 108 and within the building spaces 116. In some embodiments, an exhaust airstream 134 (see FIG. 1) may be further incorporated into the HVAC system 108 to maintain the desired barometric pressure and to allow entry of the outside airstream 126.

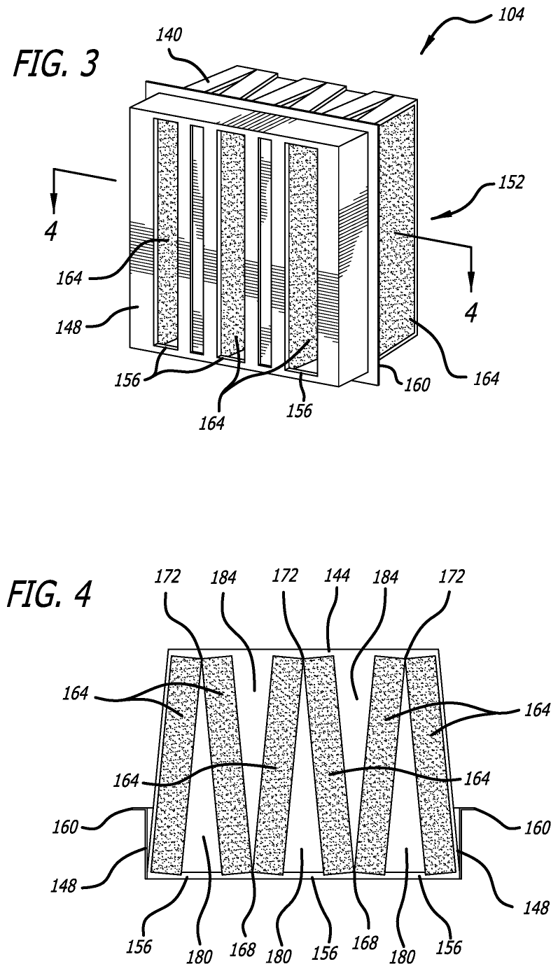

FIG. 3 illustrates an exemplary embodiment of a multi-panel air filter 104 according to the present disclosure. The multi-panel air filter 104 (hereinafter, “MPF 104”) generally is a V-bank variety of air filter, which comprises a class of filters also referred to as rigid pocket filters. V-bank filters often comprise an important element in clean room environments. V-bank filters may be implemented as pre-filters before HEPA filters, for example. The ‘V’ configuration provides more surface area than traditional filters, reduces an overall pressure drop in the HVAC system 108, and extends the usable life of downstream filters.

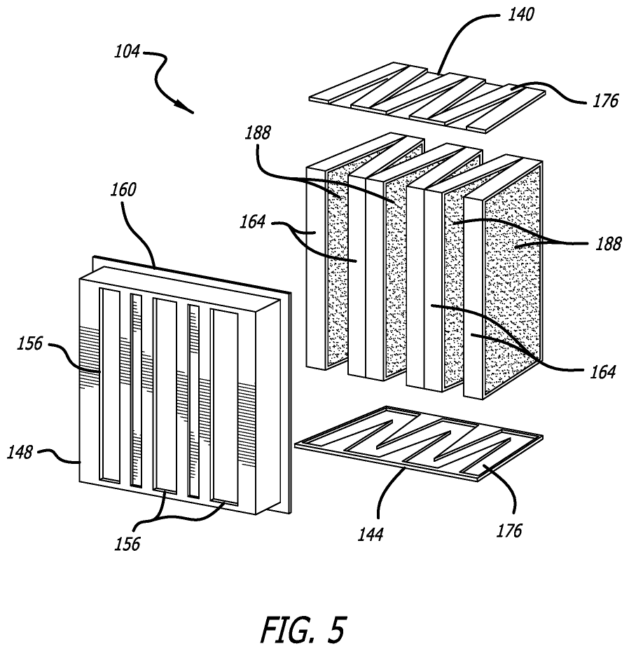

As shown in FIG. 3, the MPF 104 comprises a three-part structure that includes a top member 140, a bottom member 144 (see FIGS. 4-5), and a frame 148. The top and bottom members 140, 144 encapsulate a V-bank filter element 152 and couple with the frame 148 to provide structural rigidity. The frame 148 is configured to orient the MPF 104 within the HVAC system 108 such that the return airstream 124 is directed through the V-bank filter element 152. As such, the frame 148 includes one or more openings 156 that are configured to allow the return airstream 124 to pass through the frame 148 to the V-bank filter element 152. In some embodiments, such as the embodiment shown in FIG. 3, the frame 148 may include a lip 160 and have a shape and a size suitable for supporting the MPF 104 within the HVAC system 108. It is contemplated that the frame 148 may be formed of any rigid material suitable for supporting the MPF 104 within the HVAC system 108. Further, it is contemplated that the shape and size of the frame 148 and the lip 160 generally will vary depending upon the make and model of the HVAC system 108 for which the MPF 104 is intended to be used.

In general, the V-bank filter element 152 comprises two or more filter panels 164 that are angled with respect to one another to form one or more ‘V’-configurations. As best shown in FIG. 4, the filter panels 164 may be arranged into adjacent V-configurations wherein front edges 168 of adjacent filter panels 164 are placed in contact and rear edges 172 of adjacent filter panels 164 similarly are placed in contact. As shown in FIG. 5, each of the top and bottom members 140, 144 includes a seat 176 configured to receive respective top and bottom edges of the filter panels 164, such that the filter panels 164 are disposed in the V-configurations shown in FIG. 4. Each of the openings 156 allows the return airstream 124 to enter an upstream volume 180 between adjacent V-configurations of the filter panels 176. Upon passing through the filter panels 164, a clean airstream 128 exits the MPF 104 through a downstream volume 184 disposed between adjacent V-configurations of the filter panels 164.

The seats 176 are configured to fixate the V-configurations of the filter panels 164, such that the upstream volumes 180 between adjacent V-configurations include substantially identical angles and areas. As such, the upstream volumes 180 are substantially identical to one another. Similarly, the seats 176 are configured such that the downstream volumes 184 between adjacent V-configurations include substantially identical angles and areas, and thus the downstream volumes 184 are substantially identical to one another. It is contemplated that the top and bottom members 140, 144 may be formed of any rigid material suitable for maintaining the configuration of the seats 176 and thus preserving the V-configurations of the filter panels 164 shown in FIG. 4.

Turning, now, to FIG. 5, the filter panels 164 each comprises a filter medium 188 that provides an area through which to pass the return airstream 124 and entrap particulates and other contaminates flowing with the airstream 124. The filter medium 188 may be formed of paper, foam, cotton, spun fiberglass, or other known filter materials, woven or non-woven material, synthetic or natural, or any combination thereof. The filter medium 188 may be pleated, or otherwise shaped, or contoured so as to increase the surface area for passing the return airstream 124 to be cleaned. Thus, the length of the filter medium 188 may be greater than the length of the filter panel 164 generally, due to the pleats, such that the surface area of the filter medium 188 is greater than the surface area of the filter panel 164. Further details pertaining to the filter medium 188 may be found in U.S. patent application, entitled “Compound Air Filter,” filed on Jun. 18, 2020, and having application Ser. No. 16/905,124; U.S. patent application, entitled “HVAC Home Air Filter,” filed on Apr. 3, 2020, and having application Ser. No. 16/839,874; and U.S. patent application, entitled “HVAC System Air Filter,” filed on Jul. 17, 2019, and having application Ser. No. 16/514,954, the entirety of each of said applications being incorporated herein by reference and made a part of the present disclosure.

In some embodiments, the filter medium 188 may be a composite filter medium comprising one or more media layers, each having unique filtration properties such that the combination of media layers exhibits a relatively high filtration efficiency and a relatively low air pressure drop across the filter medium 188. For example, in one embodiment, the filter medium 188 may comprise a first media layer and a second media layer. The first media layer may comprise a fiber density that is relatively lower than the fiber density of the second media layer. Thus, the filter medium 188 may comprise a fiber density that generally increases in the direction of air flow through the filter medium 188.

It is contemplated that a practitioner may periodically clean the filter medium 188 rather than replacing the MPF 104, as is typically done with conventional air filter systems. It is envisioned that the MPF 104 may be removed from the HVAC system 108, and any trapped debris may then be removed from the HVAC system 108. In the illustrated embodiment, the MPF 104 can be cleaned by using a water hose to flush contaminants from the filter media 188 comprising the filter panels 164. In some embodiments, the top and bottom members 140, 144 may be disassembled so as to release the filter panels 164 from the frame 148 and then a water hose may be used to flush contaminants from the filter medium 188 comprising each of the filter panels 164, thereby leaving the filters clean and ready for reuse.

In the embodiment illustrated herein, the filter media 188 comprise a dried synthetic material that generally becomes surface loaded as contaminants are deposited onto upstream surfaces of the filter media 188 during use of the MPF 104 in the HVAC system 108. As will be appreciated, the dried synthetic material may be cleaned by simply using a water hose to flush the contaminants from the filter media 188. In some embodiments, the filter media 188 may be cleaned by applying the water to downstream surfaces of the filter media 188 to dislodge the contaminants from the upstream surfaces of the filter media 188. In some embodiments, however, the filter media 188 may be cleaned by applying higher-pressure water to the upstream surfaces of the filter media 188 to flush the contaminants away from the filter media 188.

In some embodiments, wherein the filter media 188 include a filter oil composition, a solvent may be used to remove the filter oil from the filter media 188. Once the filter media 188 have been sufficiently dried, a suitably formulated filter oil composition may be applied and allowed to wick into the filter media 188. The MPF 104 may then be reinstalled into the HVAC system 108. Various other cleaning methods will be apparent to those skilled in the art without deviating from the spirit and scope of the present disclosure. Further details pertaining to the filter oil composition and cleaning the filter media 188 may be found in the above-mentioned U.S. patent applications, having application Ser. Nos. 16/905,124; 16/839,874; and Ser. No. 16/514,954, the entirety of said applications being incorporated herein by reference and made a part of the present disclosure.

In some embodiments, wherein the filter medium 188 comprises the filter oil composition, the filter medium 188 may comprise at least a cotton gauze portion including 4 to 6 layers of cotton gauze disposed between two epoxy-coated aluminum wire screens. In some embodiments, however, the wire screens may be comprised of nylon, or other suitable thermoplastic material. The cotton may be advantageously treated with the above-mentioned filter oil composition so as to cause tackiness throughout microscopic strands comprising the filter medium 188. The nature of the cotton allows high volumes of airflow, and when combined with the tackiness of the filter oil composition creates a powerful filtering medium which ensures a high degree of air filtration.

During operation of the HVAC system 108, contaminant particles cling to the fibers within the volume of the filter medium 188 and become part of the filtering medium 188, a process referred to as “depth loading.” It will be appreciated that depth loading allows the MPF 104 to capture and retain significantly more contaminants per unit of area than conventional air filters. Contaminant particles are stopped by the layers of cotton gauze and held in suspension by the filter oil composition, and thus the contaminants collected on the surface of the filter medium 188 have little effect on air flow during much of the service life of the MPF 104. Moreover, as the filter medium 188 collects an increasing volume of contaminants and debris, an additional degree of filtering action begins to take place as the return airstream 124 first passes through the trapped contaminants on the surface of the filter medium 188 before passing through deeper layers within the filter medium 188. In essence, the trapped contaminants begin to operate as an additional filter material which precedes the filter medium 188. Thus, the MPF 104 continues to exhibit a high degree of air flow and filtration throughout the service life of the filter, thereby reducing operating costs of the HVAC system 108.

As will be appreciated, treating the filter medium 188 with the filter oil composition generally enables the filter medium 188 to capture contaminants by way of interception, whereby contaminants, such as dirt particles, traveling with the return airstream 124 directly contact the fibers comprising the filter medium 188 and are then held in place by the filter oil composition. Larger or heavier particles generally are captured by way of impaction, whereby inertia or momentum of the particles causes them to deviate from the path of the return airstream 124 through the filter medium 188, and instead the particles run straight into the fibers and are captured by the filter oil composition.

Particle contaminants having very small sizes may be captured by way of diffusion. As will be appreciated, small particles are highly affected by forces within the return airstream 124 through the filter medium 188. Forces due to velocity changes, pressure changes, and turbulence caused by other particles, as well as interaction with air molecules, generally causes the small particles to follow random, chaotic flow paths through the filter medium 188. Consequently, the small particles do not follow the return airstream 124, and their erratic motion causes them to collide with the fibers comprising the filter medium 188 and remain captured by the filter oil composition. Diffusion and the filter oil composition enable the MPF 104 to capture particle contaminants having sizes that are much smaller than the openings between the fibers comprising the filter medium 188. Furthermore, the filter oil composition enables the MPF 104 to capture contaminants throughout the volume of the filter medium 188, rather than only on the surface of the filter as is common with conventional air filters. The multiple layers of cotton fibers comprising the filter medium 188 coupled with the tackiness provided by the filter oil composition provide many levels of contaminant retention, thereby enabling the MPF 104 to hold significantly more contaminants per unit of area of the filter medium 188 than is possible with conventional air filters.

In some embodiments, the layers of cotton gauze treated with the filter oil composition may be coupled with portions of the filter medium 188 wherein other filtration mechanisms are used, thereby forming a composite filter medium 188 capable of removing airborne molecular contaminants and VOCs from the return airstream 124. For example, in some embodiments, the composite filter medium 188 may be comprised of a cotton gauze portion, as described herein, and an electrostatic portion. In such embodiments, the electrostatic portion of the composite filter medium 188 may be disposed downstream of the cotton gauze portion and configured to utilize electrostatic attraction and agglomeration to entrap particle contaminants. Thus, particle contaminants that would otherwise avoid directly colliding with fibers comprising the cotton gauze may be electrostatically captured and entrapped within the filter medium 188.

While the multi-panel air filter and methods have been described in terms of particular variations and illustrative figures, those of ordinary skill in the art will recognize that the multi-panel air filter is not limited to the variations or figures described. In addition, where methods and steps described above indicate certain events occurring in certain order, those of ordinary skill in the art will recognize that the ordering of certain steps may be modified and that such modifications are in accordance with the variations of the multi-panel air filter. Additionally, certain of the steps may be performed concurrently in a parallel process when possible, as well as performed sequentially as described above. To the extent there are variations of the multi-panel air filter, which are within the spirit of the disclosure or equivalent to the multi-panel air filter found in the claims, it is the intent that this patent will cover those variations as well. Therefore, the present disclosure is to be understood as not limited by the specific embodiments described herein, but only by scope of the appended claims.

What is claimed is:

1. An air filter for cleaning air within interior building spaces, comprising:
a V-bank filter element for removing contaminants from an airstream;
a top member and a bottom member for supporting the V-bank filter element;
a frame for coupling with the top member and the bottom member; and
one or more openings disposed in the frame for allowing the airstream to enter the V-bank filter element.

2. The air filter of claim 1, wherein the V-bank filter element is configured to provide more surface area than traditional filters, reduce the overall pressure drop in a HVAC system, and extend the usable life of downstream filters.

3. The air filter of claim 1, wherein the frame is configured to orient the air filter within a HVAC system such that the airstream is directed through the V-bank filter element.

4. The air filter of claim 3, wherein the frame includes a lip and has a shape and size suitable for supporting the air filter within the HVAC system.

5. The air filter of claim 1, wherein the V-bank filter element comprises two or more filter panels that are angled with respect to one another to form one or more V-configurations.

6. The air filter of claim 5, wherein the two or more panels each comprises a filter medium that provides an area through which to pass the airstream and entrap particulates and other contaminates flowing with the airstream.

7. The air filter of claim 5, wherein the two or more filter panels are arranged into adjacent V-configurations.

8. The air filter of claim 5, wherein the top member includes a seat configured to receive top edges of the two or more filter panels such that the two or more filter panels are disposed in the adjacent V-configurations.

9. The air filter of claim 8, wherein the bottom member includes a seat configured to receive bottom edges of the two or more filter panels such that the two or more filter panels are disposed in the adjacent V-configurations.

10. The air filter of claim 9, wherein the one or more openings are configured to allow the airstream to enter upstream volumes disposed between adjacent V-configurations.

11. The air filter of claim 10, wherein downstream volumes disposed between adjacent V-configurations are configured to allow a clean airstream to exit the V-bank filter element.

12. The air filter of claim 11, wherein the seats comprising the top member and the bottom member are configured to fixate the V-configurations such that the upstream volumes include substantially identical angles and areas.

13. The air filter of claim 12, wherein the seats comprising the top member and the bottom member are configured to fixate the V-configurations such that the downstream volumes include substantially identical angles and areas.

14. The air filter of claim 13, wherein the upstream volumes and the downstream volumes are configured to be substantially identical to one another.

15. A method for an air filter, comprising:
providing a filter medium comprising two or more filter panels;
arranging the two or more filter panels into a V-bank filter element;
supporting the V-bank filter element between a top member and a bottom member; and
configuring a frame to couple the top member and the bottom member.

16. The method of claim 15, wherein arranging includes arranging the two or more filter panels into adjacent V-configurations.

17. The method of claim 16, wherein supporting includes seating the two or more filter panels into the top member and the bottom member such that the two or more filter panels are disposed in adjacent V-configurations.

18. The method of claim 17, wherein seating includes fixating the V-configurations such that upstream volumes and downstream volumes are established between pairs of the two or more filter panels.

19. The method of claim 18, wherein configuring the frame includes configuring one or more openings in the frame to allow an airstream to enter the upstream volumes between adjacent V-configurations.
